(19) United States
(12) Patent Application Publication
(10) Pub. No.: US 2007/0057223 A1
(43) Pub. Date: Mar. 15, 2007

(54) VALVE HOUSING ASSEMBLY

(75) Inventor: FRITZ MULLER, Ingelfingen (DE)

Correspondence Address: HENRY M FEIEREISEN, LLC, 350 FIFTH AVENUE, SUITE 4714, NEW YORK, NY, 10118, US

(73) Assignee: GEMU Gebruder Muller Apparatebau GmbH & Co. KG, Ingelfingen (DE)

(21) Appl. No.: 11/530,188

(22) Filed: Sep. 8, 2006

(30) Foreign Application Priority Data
Sep. 9, 2005 (DE) 10 2005 043 008.2

(51) Int. Cl. F16K 27/00

(52) U.S. Cl. 251/366

(57) ABSTRACT

A valve housing includes a housing body having the shape of a hollow sphere to define an interior for accommodation of at least one valve seat. The housing body is made of at least two shells. One of the shells includes at least one inlet port, and the other one of the shells includes at least one outlet port, wherein one of the two shells includes a fitting neck for installation of a control element for a closure member which interacts with the valve seat

### CROSS-REFERENCES TO RELATED APPLICATIONS

This application claims the priority of German Patent Application, Serial No. 10 2005 043 008.2, filed Sep. 9, 2005, pursuant to 35 U.S.C. 119(a)-(d), the content(s) of which is/are incorporated herein by reference.

### BACKGROUND OF THE INVENTION

The present invention relates, in general, to a valve housing for use in a valve such as a seat valve.

Nothing in the following discussion of the state of the art is to be construed as an admission of prior art.

Valve housings for different seat valves such as slanted seat valves or the like are typically implemented as cast parts which are formed directly with an inlet port and an outlet port, and optionally a fitting neck for a control element for a closure member. As a result, each valve type requires the manufacture of a particular valve housing through a casting process. In addition, cast valve housings require complicated finishing works and thus are not only fairly expensive to produce but also relatively massive and heavy.

It would therefore be desirable and advantageous to provide a valve housing which obviates prior art shortcomings and can be universally applied to realize different valve constructions.

### SUMMARY OF THE INVENTION

According to one aspect of the present invention, a valve housing includes a housing body having the shape of a hollow sphere to define an interior for accommodation of at least one valve seat, wherein the housing body is comprised of at least two shells, one of the shells being constructed to include at least one inlet port, and the other one of the shells being constructed to include at least one outlet port, wherein one of the two shells includes a fitting neck for installation of a control element for a closure member which interacts with the valve seat.

The present invention resolves prior art problems by providing the valve housing with a hollow body configuration that is considerably lighter than a conventional cast valve housing and in addition is cost-saving. The housing body can be assembled of two or more complementing housing parts or shells to establish a modular system or kit so that the configuration of the valve housing can be best suited to the need at hand. For example, a valve housing may be assembled from two shells, whereby one shell may be constructed to include also the valve seat in addition to the inlet port and the fitting neck for the control element and the inlet port, while the other shell may be configured with one or more outlet ports, whereby the number of outlet ports can be randomly selected and positioned on the periphery of this shell at a suitable location and with suitable orientation. The provision of such a modular system for assembly of a valve housing is universally applicable and very cost-effective. Each shell of the valve housing can be suited to the desired valve type, not only as far as the number of inlet ports and outlet ports is concerned but also as far as the type of valve actuation is concerned so that the modular system of the present invention affords a user the option to design for example corner valves, valves with several drive and actuating devices, and the like.

According to another feature of the present invention, the housing body may be divided along a diametrical parting line which extends distal to the fitting neck, distal to the at least one inlet port, and distal to the at least one outlet port. In other words, the parting line extends without intersecting either one of the fitting neck, inlet and outlet ports. Thus, the parting line of the hollow spherical housing body is selected in such a way that the inlet port and/or the fitting neck are provided completely in one shell while the outlet port is provided in the other complementary shell. The housing body is hence parted by a continuous parting line that allows a firm connection of the shells to produce the hollow spherical housing body via a continuous seam.

According to another feature of the present invention, the housing body defines a principal axis and may be divided along a section plane which may be oriented at an angle of about 45° to the principal axis. In this way, the inlet and outlet ports and the fitting neck can be freely configured as they may be spaced from one another about a relatively large area of the sphere periphery. As a result, corner valves, in which the inlet and outlet ports are positioned to one another at an angle of suitably smaller than 180°, can be realized in a simple manner.

The firm connection of the shells along the parting line can be implemented in many ways. Examples include welding, especially laser welding, clamping, bracing, triclamp connection, threaded engagement with flanged connection, or combinations thereof. Any of these jointing methods results not only in a physical firm connection but exhibits also a reliable fluid tightness.

According to another feature of the present invention, the shells may be made of plastic, suitably through an injection molding process, or of metallic material, e.g. high-quality steel, suitably through a deep drawing process. Any of these manufacturing processes for the shells are cost-effective so that the shells can be produced inexpensively despite the use of high-quality materials.

According to another feature of the present invention, the outlet port or outlet ports can be variably secured to the associated shell. In this way, this shell can be best suited to the application at hand by attaching the outlet port or outlet ports at the suitable location(s) and at desired angle(s). This shell may conceivably be retrofitted also subsequently with the outlet port(s), without requiring manufacture of the shell with the outlet ports(s) beforehand. The outlet ports may have different inner diameters so that the valve housing according to the invention is applicable like an adapter between different pipe diameters of a piping network.

According to another feature of the present invention, the valve seat may be disposed in close relationship to the outlet port. In this way, enhanced flow conditions can be attained for a fluid flowing through the housing body.

According to another feature of the present invention, web-like supports may be provided in the interior of the housing body for support of the inlet port or inlet ports. In this way, the valve seat near the inlet port is provided with sufficient stability to cope with closing pressures applied by the closure member which interacts with the valve seat.

According to another feature of the present invention, at least one pressure sensor may be arranged in the interior of the housing body to allow a reliable adjustment and monitoring of pressure conditions inside the housing body.

As a result of the hollow spherical configuration of the housing body, a valve housing according to the invention can also be constructed as multiway valve.

According to another feature of the present invention, the shells may be provided with complementary centering tabs in an area of the parting line for allowing a reliable centering and alignment of the shells.

According to another feature of the present invention, the valve seat may be part of a separate valve seat structure for accommodation in the interior of the housing body. This even further expands the universality and freedom of design as far as construction of valves is concerned. Thanks to the modular system and the separate provision of a valve seat structure, the advantages of the modular system become even more effective since the shells of the housing body can be designed and manufactured free and independent of the configuration of the valve seat and its disposition. Moreover, as the valve seat represents a separate structure, the housing body of the modular system allows implementation of different valve seat types by selecting the required components. Production and manufacture are thus simplified since the valve seat can be designed in any suitable configuration without consideration of the shell configuration.

According to another feature of the present invention, the shells can be aligned, suitably through rotation, in relation to the valve seat structure. Using the three components for assembly of the valve housing, namely the two shells and the valve seat structure, these three components can be oriented relative to one another, e.g. through rotation, in a way that best suits the need at hand. This further improves the freedom of design.

According to another feature of the present invention, the valve seat structure and the shells may firmly be connected together, after alignment, by any suitable joining process. Examples include welding, laser welding, clamping, bracing, triclamp connection, threaded engagement with flanged connection, or combinations thereof.

According to another feature of the present invention, the valve seat structure may have a disk-shaped configuration. The separate valve seat structure may hereby be received in the interior of the housing body at the parting line between the shells.

In accordance with the present invention, a modular system is provided for designing a valve housing that best suits the needs of a user and is thus characterized by a versatility that allows realization of different valves through application of a suitable manufacturing process.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic side view of one embodiment of a valve housing according to the present invention;

FIG. 2 is a schematic sectional view of the valve housing of FIG. 1;

FIG. 3 is a schematic sectional view of another embodiment of a valve housing according to the present invention;

FIG. 4 is a detailed perspective view of a valve seat structure for incorporation in a valve housing according to the present invention; and

FIG. 5 is a schematic sectional view of the valve seat structure.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

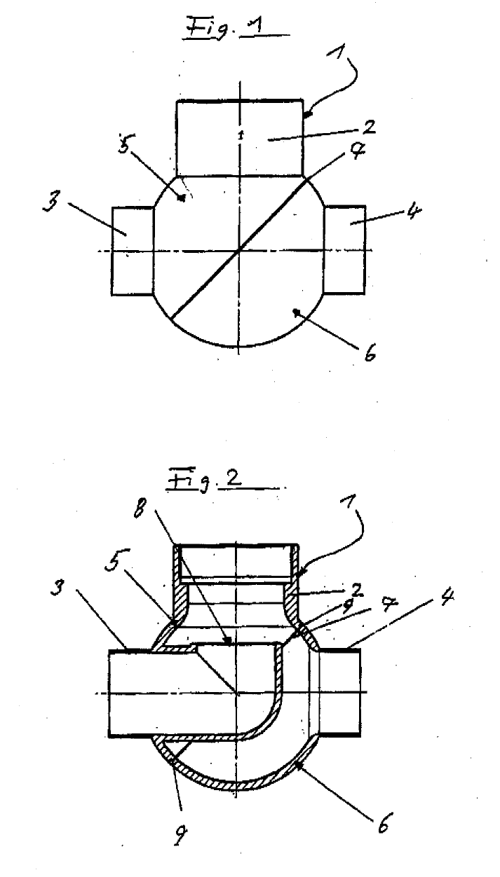

Turning now to the drawing, and in particular to FIG. 1, there is shown a schematic side view of one embodiment of a valve housing according to the present invention, generally designated by reference numeral 1. In general, the valve housing 1 includes an inlet port 3, an outlet port 4, and a fitting neck 2 for attachment of an unillustrated valve drive which is provided with a control element for a closure member. The valve housing 1 has a housing body which is configured in the form of a hollow sphere and comprised of at least two shells 5, 6 separated from one another along a parting line 7. In the non-limiting example of FIG. 1, the shell 5 includes the inlet port 3 and the fitting neck 2, whereas the other shell 6 includes the outlet port 4. The parting line 7 between the shells 5, 6 extends at an angle of 45° in relation to a principal axis of the hollow spherical housing body. In general, the course of the parting line 7 of the housing body is selected in such a way as to prevent any intersection with either one of the fitting neck 2, inlet port 3 and outlet port 4.

As is shown in FIG. 2, which is a schematic sectional view of the valve housing 1, the shells 5, 6 have a hollow-shaped configuration. The shells 5, 6 may be made of plastic and manufactured through an injection molding process. As alternative, the shells 5, 6 may be made of metallic material, e.g. high-quality steel, and manufactured through a deep drawing process.

Disposed inside the housing body of the valve housing 1 is a valve seat 8 which is configured in the depicted non-limiting example in the form of a plane seat. Of course, the valve seat may also be configured as a slanted seat. Although not shown in detail, an unillustrated closure member cooperates with the valves seat 8 and is operated by an actuator for movement between closing and opening positions. The control element with the closure member as well as the drive can therefore be mounted via the fitting neck 2 to the housing body of the valve housing 1. In order to realize enhanced flow conditions in the inlet port 3 and outlet port 4, the valve seat 8 is suitably positioned as close as possible to the outlet port 4.

The shells 5, 6 can be connected together along the parting line 7 in many ways. Examples of joining processes include welding, especially laser welding, clamping, bracing, triclamp connection, threaded engagement with flanged connection, or combinations thereof. In order to accurately position the shells 5, 6 relative to one another, the confronting ends of the shells 5, 6 are formed with centering shoulders 9 at the parting line 7 between the shells 5, 6.

Although the illustrated embodiment of the valve housing 1 depicts the housing body as being composed of two shells 5, 6, it will be appreciated by persons skilled in the art that the housing body may, of course, be comprised of more than two shells or housing parts in order to realize the hollow spherical shape of the valve housing 1, whereby the individual housing parts are then connected together at the respective parting lines. In addition, it is, of course, also possible to construct the shell 5 with more than one inlet port 3, and to accommodate more than one valve seat 8 inside the housing body of the valve housing 1.

It should further be noted that although the inlet port 3 and the outlet port 4 are illustrated in FIGS. 1 and 2 in substantial alignment and with substantially identical diameter, such illustration is for expediency only and should not be regarded as a limitation since such configuration is far from essential to this invention. It is, of course, also conceivable to position the outlet port 4 at an angle of less than 180° in relation to the inlet port 3, or vice versa, without departing from the spirit of the present invention. Moreover, the shell 6 may also include more than one outlet port 4, and the plurality of outlet ports 4 may also have different inner diameters so as to allow the valve housing 1 to be used as an adaptor for connection to different pipe diameters.

If need be, at least one pressure sensor may be arranged inside the housing body of the valve housing 1 for determining and monitoring a pressure inside the valve housing 1. Signals of the pressure sensor may hereby be used for control purposes, for example for operating the closure member.

The connection between the two shells 5, 6 along the parting line 7 can be realized by a welding seam, as indicated in FIGS. 1 and 2, although the shells 5, 6 may, of course, also be firmly connected to one another through clamping and/or bracing. An example involves a triclamp connection which includes flanges and an enveloping part in the form of a tension ring. In addition, the shells 5, 6 may also be joined together by a flange connection and associated bolts.

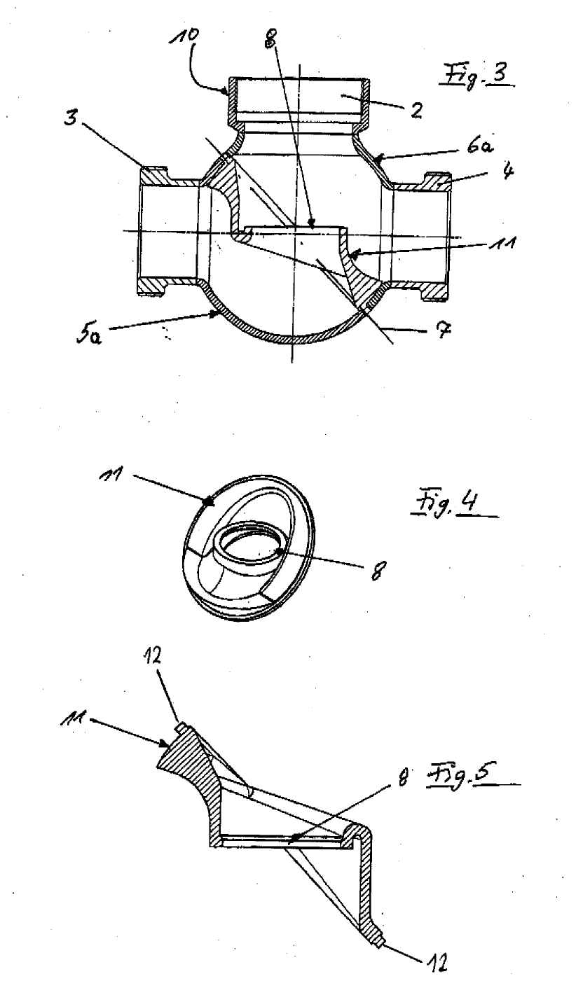

Referring now to FIG. 3, there is shown a schematic sectional view of another embodiment of a valve housing according to the present invention, generally designated by reference numeral 10. In the following description, parts corresponding with those in FIG. 1 will be identified, where appropriate for the understanding of the invention, by corresponding reference numerals followed by an “a”. The valve housing 10 has a housing body comprised of a shell 5a which includes only the inlet port 3, and a shell 6a which includes the outlet port 4 and the fitting neck 2. Disposed inside the housing body is a separate valve seat structure 11 to form the valve seat 8. The valve seat structure 11, which supports the valve seat 8 only, may be made of a same or similar material as the shells 5a, 6a. Thus, the shells 5a, 6a can be dimensioned and manufactured independently of the design of the valve seat 8.

Manufacture of the valve housing 10 for example can be carried out as follows: Prefabricated shells 5a, 6a of a plurality of shells of the modular system are combined with a desired valve seat structure 11 that is suitable for a particular valve configuration. The selected shells 5a, 6a and the valve seat structure 11 are suitably oriented, through rotation for example, to one another. Once these components are properly aligned and the valve seat structure 11 is positioned at the parting line 7 of the valve housing 10, the shells 5a, 6a and the valve seat structure 11 are firmly connected together by welding, in particular laser welding, clamping, bracing, triclamp connection, threaded engagement with flanged connection, or the like. The shells 5a, 6a can thus be designed and made independent of the valve seat structure 11. Likewise, the valve seat structure 11 can be designed and made independent of the shells 5a, 6a. Thus, as the valve seat structure 11 is solely provided to form the valve seat 8, the latter is reliably and safely supported in the shells 5a, 6a of the valve housing 10 so that closing forces and applied forces during operation can be reliably absorbed. In addition, the valve seat structure 11 can be constructed to enhance flow dynamics so that a fluid flow inside the valve housing 10 is least interfered with.

FIG. 4 shows a detailed perspective view of the valve seat structure 11 and it can be seen that the valve seat structure 11 has a disk-like configuration.

FIG. 5 shows a schematic sectional view of the valve seat structure 11 and it can be seen that the valve seat structure 11 is formed at its terminal ends with centering tabs 12 to facilitate a proper alignment of the shells 5a, 6a and the valve seat structure 11 during assembly.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A valve housing, comprising a housing body having the shape of a hollow sphere to define an interior for accommodation of at least one valve seat, said housing body comprised of at least two shells, one of the shells being constructed to include at least one inlet port, and the other one of the shells being constructed to include at least one outlet port, wherein one of the two shells includes a fitting neck for installation of a control element for a closure member which interacts with the valve seat.

2. The valve housing of claim 1 constructed for a seat valve.

3. The valve housing of claim 1, wherein the one shell is constructed to include the valve seat.

4. The valve housing of claim 1, wherein the housing body is divided along a diametrical parting line which extends distal to the fitting neck, the at least one inlet port, and the at least one outlet port.

5. The valve housing of claim 1, wherein the housing body defines a principal axis and is divided along a section plane oriented at an angle of about 45° to the principal axis.

6. The valve housing of claim 1, wherein the shells are firmly connected together by a process selected from the group consisting of welding, laser welding, clamping, bracing, triclamp connection, threaded engagement with flanged connection, and combinations thereof.

7. The valve housing of claim 1, wherein the shells are made of plastic.

8. The valve housing of claim 7, wherein the shells are made of plastic through an injection molding process.

9. The valve housing of claim 1, wherein the shells are made of metallic material.

10. The valve housing of claim 1, wherein the shells are made of high-quality steel.

11. The valve housing of claim 1, wherein the shells are made of metallic material through a deep drawing process.

12. The valve housing of claim 1, wherein the other one of the shells is constructed to allow variable attachment of the outlet port.

13. The valve housing of claim 1, wherein the valve seat is disposed in close relationship to the outlet port.

14. The valve housing of claim 1, further comprising web-like supports in the interior of the housing body for support of the inlet port.

15. The valve housing of claim 1, further comprising at least one pressure sensor arranged in the interior of the housing body.

16. The valve housing of claim 1, constructed as multiway valve.

17. The valve housing of claim 4, wherein the shells are provided with complementary centering tabs in an area of the parting line for alignment of the shells.

18. The valve housing of claim 1, wherein the other one of the shells has plural outlet ports of different nominal diameter.

19. The valve housing of claim 1, further comprising a separate valve seat structure for accommodation in the interior of the housing body, said valve seat structure providing the valve seat.

20. The valve housing of claim 19, wherein the shells are constructed for alignment in relation to the valve seat structure.

21. The valve housing of claim 19, wherein the shells are constructed for rotation in relation to the valve seat structure to allow alignment of the shells in relation to the valve seat structure.

22. The valve housing of claim 19, wherein the valve seat structure and the shells are firmly connected together, after alignment, by a process selected from the group consisting of welding, laser welding, clamping, bracing, triclamp connection, threaded engagement with flanged connection, and combinations thereof.

23. The valve housing of claim 19, wherein the valve seat structure has a disk-shaped configuration.

24. The valve housing of claim 4, further comprising a separate valve seat structure received in the interior of the housing body at the parting line between the shells.

25. A modular system for assembly of a valve housing, comprising:
a plurality of first housing shells including one or more inlet ports, wherein some of the first housing shells include a fitting neck;
a plurality of second housing shells including one or more outlet ports, wherein some of the second housing shells include a fitting neck, wherein the fitting neck of the first and second housing shells are provided for attachment of a closure member, wherein any one of the first housing shells is connectable to any one of the second housing shells for providing a hollow-spherical valve housing; and
a valve seat structure for accommodation in the valve housing, said valve seat structure providing the valve seat for interaction with the closure member.

26. The modular system of claim 25, further comprising at least one pressure sensor for determining a pressure inside the valve housing.
